(19) United States
(12) Patent Application Publication
(10) Pub. No.: US 2016/0267810 A1
(43) Pub. Date: Sep. 15, 2016

(54) CULINARY BOARD GAME

(71) Applicant: So You Think You're a Chef, LLC, Benzonia, MI (US)

(72) Inventor: William J. Witowski, III, Benzonia, MI (US)

(21) Appl. No.: 15/066,153

(22) Filed: Mar. 10, 2016

Related U.S. Application Data
(60) Provisional application No. 62/131,286, filed on Mar. 11, 2015.

(51) Int. Cl. G09B 19/00; A63F 3/00

(52) U.S. Cl. CPC G09B 19/0092; A63F 3/00006

(57) ABSTRACT

What is provided is a method and apparatus for an educational food preparation and culinary-based board game that is adapted for multiple players. The board game apparatus comprises a game board, which comprises a travel path around the perimeter of the game board. The game board further comprises at least one shortcut path that connects one of the plurality of category spaces directly with a finishing space. The board game apparatus further comprises a plurality of cards having printed trivia questions and answers related to food, food preparation, nutrition, and kitchen fundamentals. The object of the board game is for a player to be the first to move each player piece around the game board by answering questions correctly in various categories in order to reach their original starting space or by using one of the shortcut paths on the game board.

### PRIORITY CLAIM

This patent application claims priority to and the benefit of the filing date of provisional patent application U.S. Ser. No. 62/131,286 filed on Mar. 11, 2015, which is incorporated herein in its entirety.

### FIELD

This patent application relates to a method for playing a board game and a board game apparatus and, more specifically, to a board game involving food and nutrition.

### BACKGROUND

Board games that provide educational and useful information to the players, while at the same time providing entertainment, have become very popular. Several popular board games involve moving around a game board by rolling a die (or dice) and answering questions relating to specific categories or topics. However, there are very few recreational and educational games relating to food, food preparation, and nutrition.

A growing number of individuals are becoming aware of the importance of good nutrition and diet in their everyday lives and have become interested in cooking. The growth in the culinary industry has resulted in an increased interest in healthy food preparation and food knowledge. However, many food enthusiasts (foodies) are not aware of how many of their favorite foods are prepared or the ingredients and nutritional components of those foods. Even though there is educational information regarding food preparation and nutrition in the form of books, videos, charts, and diagrams, some individuals do not have the desire or attention span to learn from the existing medium. Thus, there is a need for a recreational and educational way to teach individuals about food, food preparation, nutritional values, and kitchen fundamentals.

### SUMMARY

What is provided is a method and apparatus for an educational food preparation and culinary-based board game that is adapted for multiple players. Described embodiments provide a board game apparatus comprising a game board, which comprises a travel path around the perimeter of the game board. The travel path comprises a plurality of category spaces and a plurality of starting spaces. The game board further comprises at least one shortcut path that connects one of the plurality of category spaces directly with a finishing space. The shortcut path comprises a plurality of shortcut spaces.

Described embodiments of the board game apparatus also comprise at least one six-sided die and a plurality of cards having printed trivia questions and answers related to food, food preparation, nutrition, and kitchen fundamentals. Each of the plurality of cards is associated with one of the plurality of category spaces, the plurality of starting spaces, or the plurality of shortcut spaces.

The object of the board game is for one player or team of players to be the first player or team to have both of their player pieces reach the finishing space on the game board. The player or team win the game by either being the first player or team to move each player piece around the game board by answering questions correctly in various categories in order to reach their original starting space or by using one of the shortcut paths on the game board.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is an exemplary embodiment of a plan view of the board game apparatus;

FIG. 2 is an exemplary embodiment of a plan view of the front of a Health Inspector card;

FIG. 3 is an exemplary embodiment of a plan view of the front of a First Cook card;

FIG. 4 is an exemplary embodiment of a plan view of the front of a Culinary Student card;

FIG. 5 is an exemplary embodiment of a plan view of the back of a Dietitian card;

FIG. 6 is an exemplary embodiment of a plan view of the front of a Head Chef card;

FIG. 7 is an exemplary embodiment of a plan view of the front of a Pastry Chef card;

FIG. 8 is an exemplary embodiment of a plan view of the front of a Sous Chef card;

FIG. 9 is an exemplary embodiment of a plan view of the front of a Chef Says card.

### DETAILED DESCRIPTION

In the following detailed description, numerous specific details are set forth in order to provide a thorough understanding of the examples as defined in the claimed subject matter, and as an example of how to make and use the examples described herein. However, it will be understood by those skilled in the art that claimed subject matter is not intended to be limited to such specific details, and may even be practiced without requiring such specific details. In other instances, well-known methods, procedures, and components have not been described in detail so as not to obscure the examples defined by the claimed subject matter.

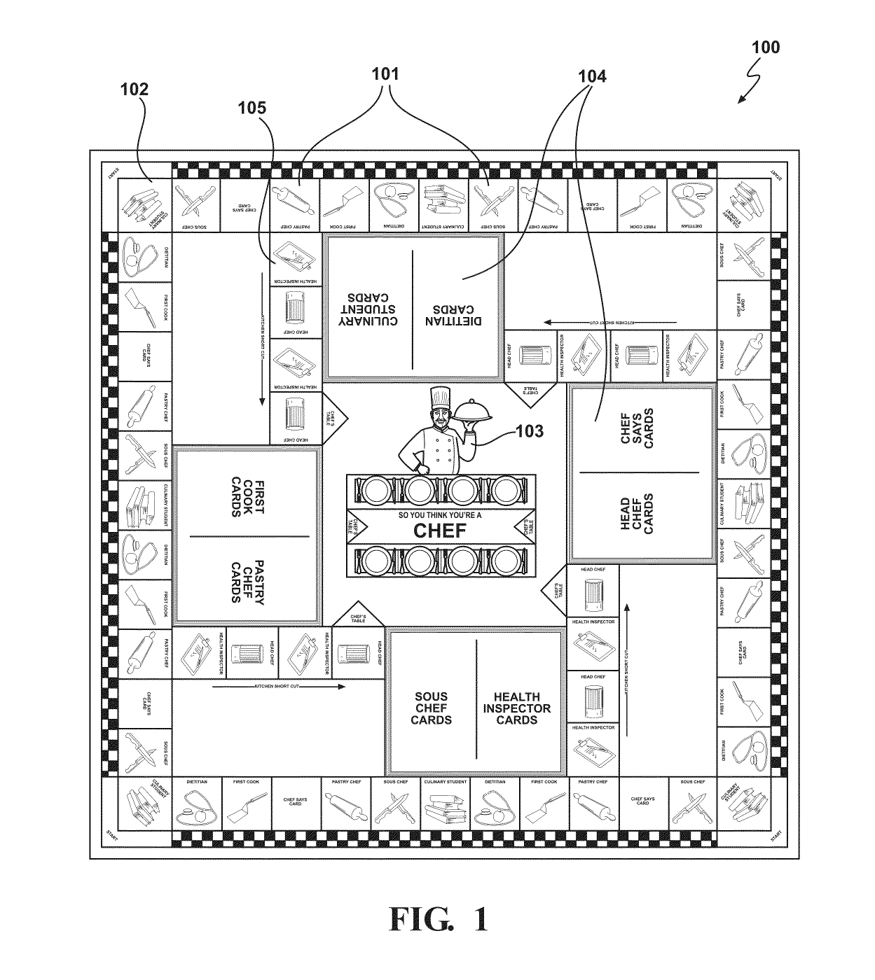

Referring to FIG. 1, FIG. 1 shows an exemplary embodiment of a plan view of the board game apparatus including a game board 100. The game board 100 has a square shape and a plurality of category spaces 101 around the perimeter of the game board 100 to allow for movement from one space to another. Other suitable geometries may be used for the game board 100, as well. Each side of the game board 100 includes the same category spaces 101 arranged in the same order. In one embodiment, the game board 100 includes twelve category spaces 101 on each side of the game board 100. Each category space 101 includes instructions that a player or a team of players whose player piece lands on the category space 101 should follow. In one embodiment, the category spaces 101 have specific wording and designs associated with a category of cards that each player or team of players must draw.

Each player or team has his or her own player pieces. The player pieces are to be moved along category spaces 101 on the game board 100. The category spaces 101 together form a travel path 106 that the player pieces move about. The exact number of category spaces 101 that each player piece moves is determined by a number generating device, such as a six-sided die or six-sided dice. A player piece may be, for example, any small object that may be readily placed on one of the category spaces 101 on the game board 100. In one embodiment, the player pieces are salt and pepper shakers with each player or team having salt and pepper shakers comprising a distinct color for identification purposes.

Each of the four sides of the game board 100 comprises a starting space 102 to designate the initial location for each of the player pieces being used to play the game. In some embodiments, four player pieces may be positioned on each of the four starting spaces 102 at the beginning of the game. The game board 100 also includes a finishing space 103 that may be accessed from four different paths and that may be located in the middle of the game board 100. In one embodiment, the finishing space 103 may be identified as the Chef's Table.

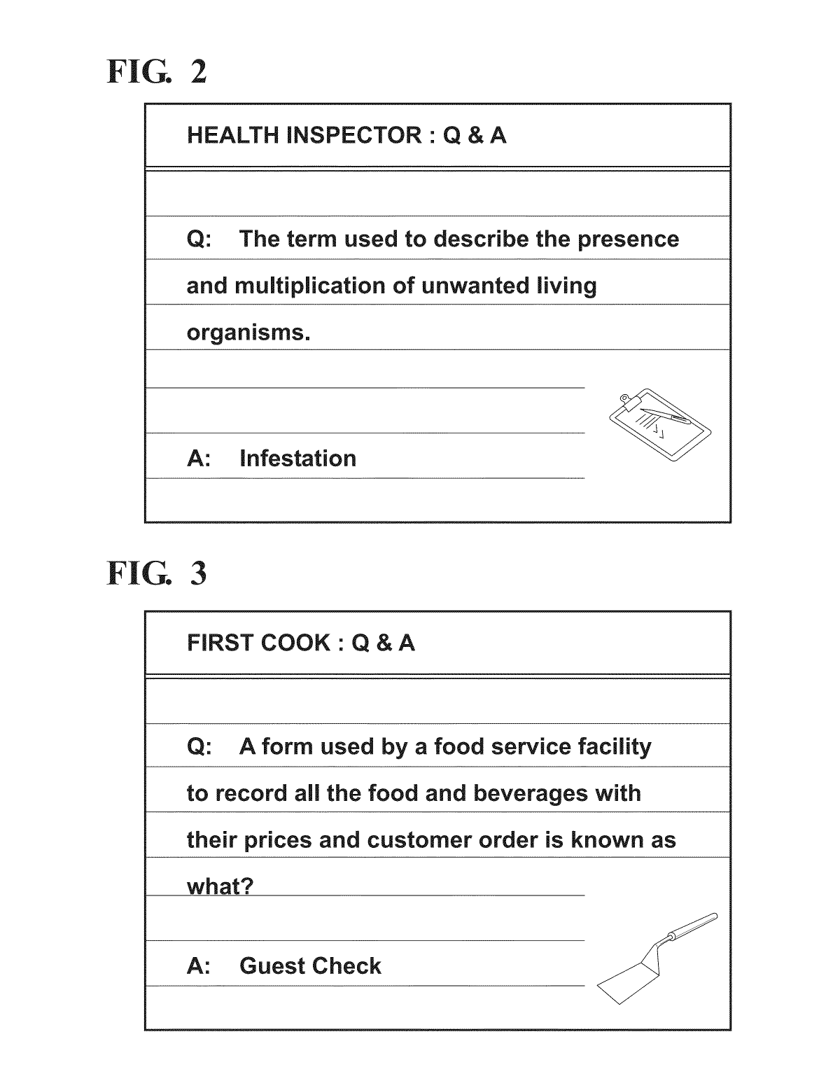

In some examples, the game board 100 may include a plurality of designated card spaces 104 in order to serve as a specific location for storing a plurality of cards (cards shown in FIGS. 2-9). The plurality of card spaces 104 may be located at various positions on the game board 100, with their orientation not having any significance to the outcome of the game. In one embodiment, the game board 100 contains eight designated card spaces 104, which correspond to eight different decks of cards (cards shown in FIGS. 2-9).

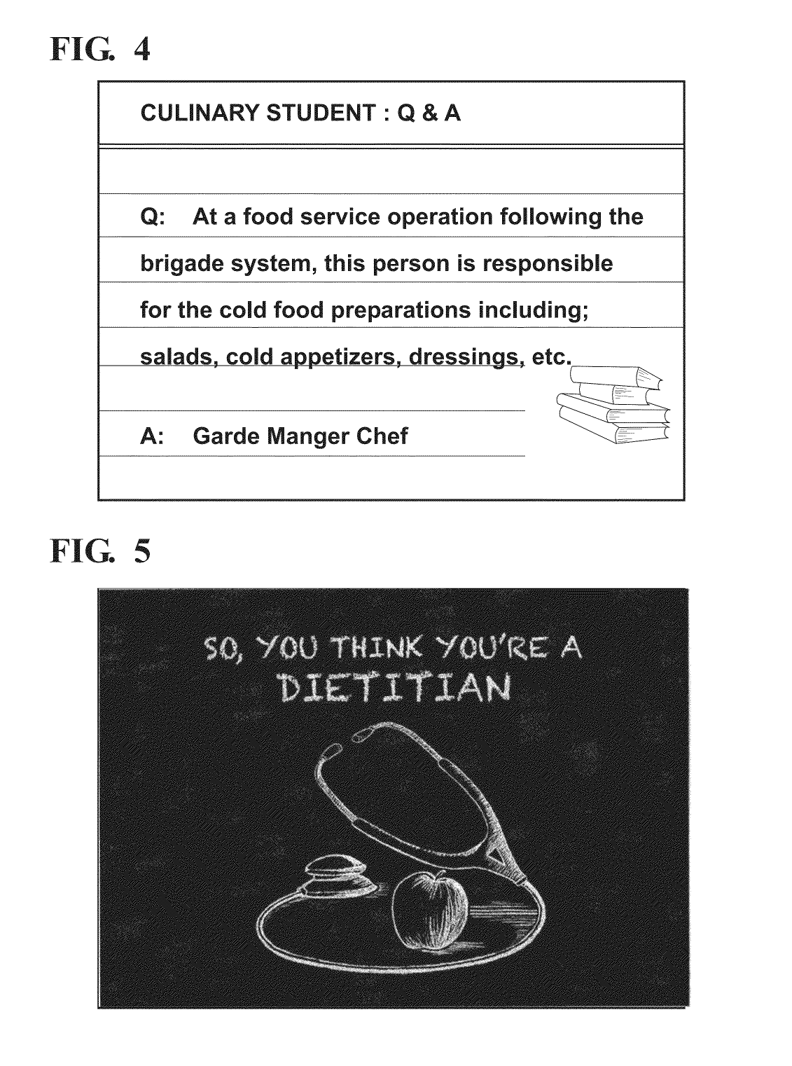

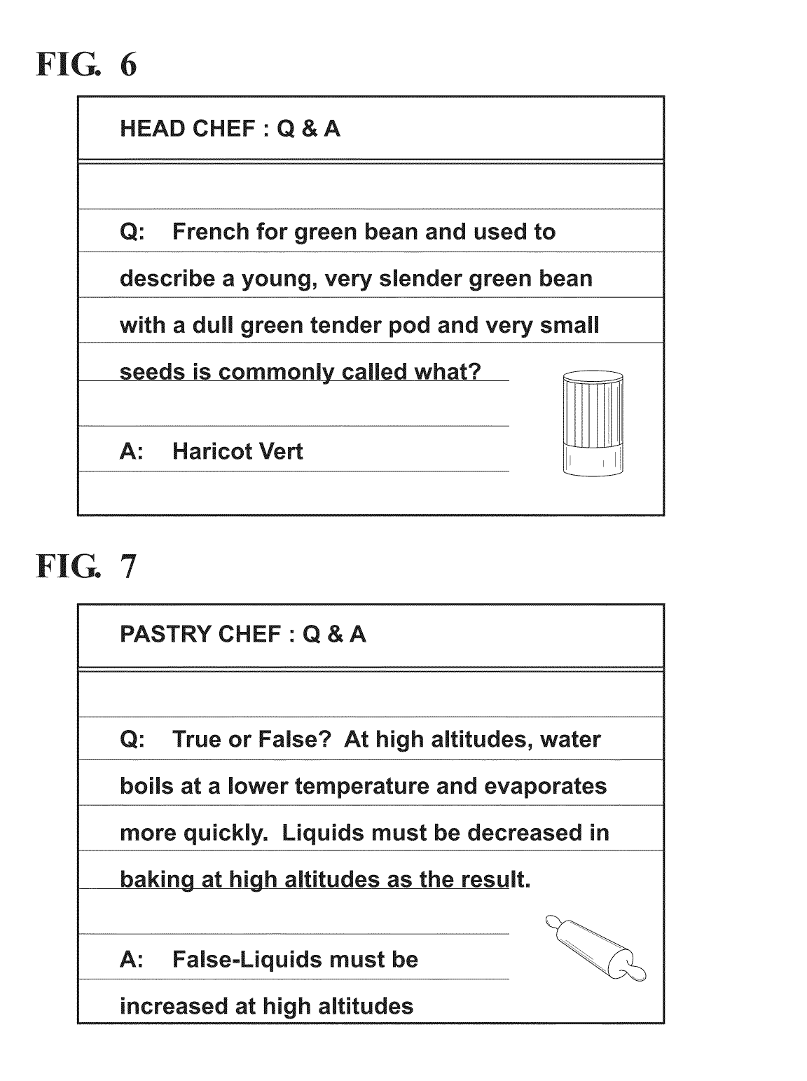

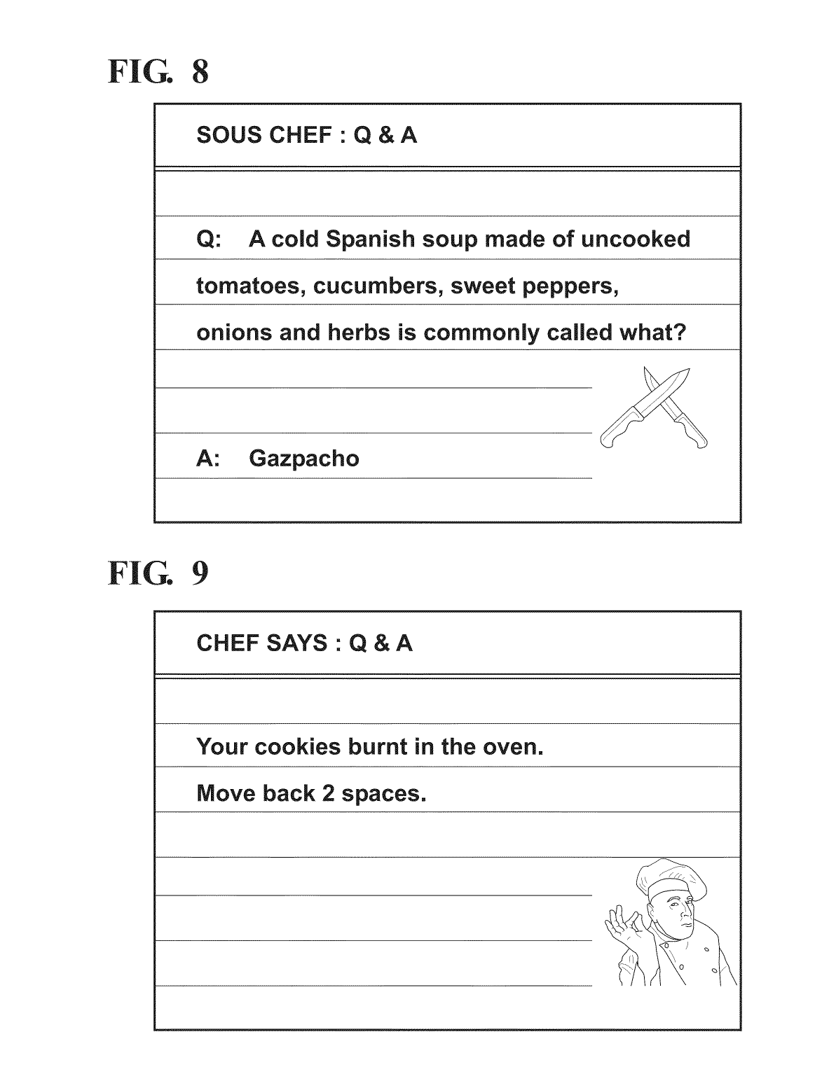

The board game includes a plurality of cards specifically associated with each of the category spaces 101 located on the game board 100. In some embodiments, the plurality of cards are arranged in decks by occupational categories, designated as “Chef Says” cards, as shown in FIG. 9; “Health Inspector” cards, as shown in FIG. 2; “Dietitian” cards, as shown in FIG. 5; “Culinary Student” cards, as shown in FIG. 4; “Pastry Chef” cards, as shown in FIG. 7; “Sous Chef” cards, as shown in FIG. 8; “1st Cook” cards, as shown in FIG. 3; and “Head Chef” cards, as shown in FIG. 6. In one embodiment, the board game includes 20 “Chef Says” cards, 20 “Health Inspector” cards, 30 “1st Cook” cards, 30 “Culinary Student” cards, 30 “Pastry Chef” cards, 30 “Sous Chef” cards, 30 “Head Chef” cards, and 20 “Dietitian” cards. In some examples, the cards have printed trivia questions and answers to the trivia questions relating to food, food preparation, and nutrition. In other examples, the cards comprise information associated with food, food preparation, and nutrition, along with action items required to be performed by the players or teams. In one embodiment, the questions and answers are written in the form of recipes on the cards and are stored in recipe boxes. In one embodiment, each of the cards, besides the “Chef Says” cards, includes one question and one answer. The “Chef Says” cards include specific activity instructions that each player or team must follow, instead of responding to a specific category of questions. For example, a “Chef Says” card may instruct the player or team to move forward or backward two spaces on the game board 100. After the player or team moves their player piece along the travel path 106 to another category space 101, they will need to wait until their next turn to draw the card associated with the category space 101 in order to either answer a question or to perform an action.

The board game is played by at least two players or two teams. In some examples, the board game may be played by up to eight players or up to four teams with up to two players per team. Each player or team chooses two different player pieces to represent them on the game board 100. In one embodiment, the player pieces are different colored salt and pepper shakers. Each player or team then positions their respective player pieces on one of the four starting spaces 102 of the game board 100. After all of the decks of cards are stacked on their respective designated card spaces 104 on the game board 100, each player or team may roll the die or dice to determine the order of play. The order of play may be determined by a variety of measures, such as the highest number rolled on the die. All play then proceeds clockwise along the travel path 106 of the game board 100.

Once order of play for playing the board game has been determined, the player or team that was predetermined to go first must either answer a question printed on the category of cards associated with the starting space 102 or perform an identified action. An opposing player or team draws a card from the specific category of cards and either asks the questions or provides instructions for an action to the player or team performing the turn. Each answer provided by a player must begin with the words “Chef Says” followed by the answer to the question. If an opposing player determines that another player did not answer a question beginning with the words “Chef Says,” the player providing the answer must immediately draw a “Chef Says” card from the game board 100 and follow the instructions provided by the respective card.

In some embodiments, the starting spaces 102 are designated as “Culinary Student” spaces and the first player or team must answer the “Culinary Student” question correctly to roll the die and advance to other category spaces 101 along the travel path 106. If the question is not answered correctly, the next player or team takes a turn. Prior to a different player or team taking a turn, the correct answer must be read out loud from the card in order to promote the educational components of the board game. No player or team may move their player pieces from any starting space 102 or category space 101 without either correctly answering the question on the card or performing the action specified by the card. Some examples of actions including moving either clockwise (forward) or counter-clockwise (backward) on the game board 100.

Upon answering the question correctly, play proceeds with each player or team taking a turn to roll the die and moving their player piece to another category space 101 along the travel path 106 on the game board 100. Then, the next player or team takes a turn. During the next turn, the original player or team may earn the roll of the die again by answering a question or performing an activity as instructed by the specific category of cards corresponding to the category space 101 where the player piece has landed. Each team or player may only roll the die once per turn. The questions in the categories of cards vary in difficulty and distinguish the various categories into levels, with the questions becoming more difficult as the levels increase. In one embodiment, level 1 corresponds to the Culinary Student, level 2 corresponds to the Culinary Student, level 3 corresponds to the Dietitian, level 4 corresponds to the First Cook, level 5 corresponds to the Pastry Chef, level 6 corresponds to the Sous Chef, level 7 corresponds to the Head Chef, and level 8 corresponds to the Health Inspector.

The object of the board game is to become the first player or team to get both of their player pieces into the finishing space 103 of the game board 100. A player or team may get both of their player pieces into the finishing space 103 by either (1) moving each player piece around the perimeter of the game board 100 along the travel path 106 by answering questions correctly in various categories in order to at least reach the player's or team's original starting space 102 or (2) by using a shortcut path 105 on the game board 100. In order to potentially save time and to avoid answering additional questions, the player or team may consider using a shortcut path 105. Each shortcut path 105 comprises a plurality of shortcut spaces that lead from some of the category spaces 101 around the perimeter of the game board 100 to the finishing space 103 in the center of the game board 100. The shortcut spaces are associated with a plurality of cards that specify certain categories. In one embodiment, there are four shortcut paths 105 located on the game board 100 and each of the shortcut paths 105 comprises two shortcut spaces designated as “Health Inspector” and two spaces designated as “Head Chef.” In this embodiment, each shortcut path 105 is directly adjacent to a category space 101 designated as “Pastry Chef.”

After a player or team successfully moves their first player piece around the entire perimeter of the game board 100 along the travel path 106 back to at least their original starting space 102, the player piece is placed in the finishing space 103. If a roll of a die results in a player or team moving past their original starting space 102, the player or team can still place one of its player pieces in the finishing space 103. Alternatively, a player or team can use a shortcut path 105 to reach the finishing space 103 with its first player piece. On a player or team's next turn, the player or team continues playing the board game by using its second player piece.

In some embodiments, after a player or team correctly answers a question from the “Pastry Chef” category, the player or team may either continue moving around the travel path 106 or may move into one of the shortcut paths 105. The player or team of players must decide whether they will take a shortcut path 105 prior to rolling the die. If the player or team elects to take a shortcut path 105 and the player or team rolls a four or less on the die, the player or team will move to one of the spaces on the shortcut path 105, such as “Health Inspector” and “Head Chef”. On the next turn, the player or team must answer a question corresponding to the specific space on the shortcut path 105 and then roll again. The “Health Inspector” and “Head Chef” spaces will typically correlate with more challenging questions for the player or team than the questions associated with the “Pastry Chef” category. In some embodiments, in order to skip the spaces and questions associated with the shortcut path 105 and to reach the finishing space 103 directly, the player or team must roll at least a five on the die.

The board game is family oriented and educational as it may be played by children and adults of various ages. A junior version of the board game that is more suitable for younger ages may involve a set of questions with a lower level of difficulty. In one embodiment, this version of the board game is known as the Family Addition. A more advanced version of the board game is known as the Pro Addition. Additional cards printed with more questions and answers may be added to the board game. Also, the cards may be printed in other languages besides English to offer versions of the board game to non-English speaking individuals.

Certain aspects of the embodiments may be modified without departing from the inventive concept. For example, the colors and designs of the cards and spaces can be modified to employ any visual similarity other than color. For example, spaces and cards may have similar border decoration or other visually distinguishable characteristics readily enabling cards to be visually associated with their corresponding spaces. Also, the number of spaces on the game board may be varied for different versions of the board game. Further, the cards may be replaced or supplemented by any suitable medium for conveying the subject matter.

The board game apparatus does not need to comprise a game board. Even though conventional game boards are made from paper or plastic and have imprinted images containing position spaces needed to play the game, other means for playing the board game may exist. In other examples, the image of the board game may be projected onto a screen or other surface, or it could be provided as a dynamic display on a cathode ray tube, flat screen display, computing device, or any functionally equivalent device. Thus, the board game method and apparatus disclosed herein may be applicable to non-board games, such as computer and video games, online games, and games shows.

It will, of course, be understood that, although particular embodiments have just been described, the claimed subject matter is not limited in scope to a particular embodiment or implementation. Likewise, an embodiment may be implemented in any combination of systems, methods, or products made by a process, for example.

In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that claims are intended to cover all such modifications or changes as fall within the true spirit of claimed subject matter.

1. A game apparatus comprising:
a game board, the game board comprising a travel path, the travel path comprising a plurality of category spaces and a plurality of starting spaces, the game board further comprising at least one shortcut path that connects one of the plurality of category spaces directly with a finishing space, the shortcut path comprising a plurality of shortcut spaces;
a set of playing pieces capable of being moved along the game board;
at least one six-sided die; and
a plurality of cards, each of the plurality of cards is associated with one of the plurality of category spaces, the plurality of starting spaces, or the plurality of shortcut spaces.

2. The game apparatus of claim 1, each of the plurality of cards having a printed trivia question and answer related to a group consisting of food, food preparation, and nutrition

3. The game apparatus of claim 1, the game board further comprising a plurality of designated card spaces for the placement of the plurality of cards.

4. The game apparatus of claim 1, the plurality of starting spaces are each associated with one of a plurality of players.

5. The game apparatus of claim 1, the plurality of cards are arranged in a plurality of decks on the plurality of designated card spaces, each of the plurality of decks is associated with a different category relating to a group consisting of food, food preparation, and nutrition.

6. The game apparatus of claim 5, the plurality of decks comprising:
a deck of “Health Inspector” cards;
a deck of “Culinary Student” cards;
a deck of “Pastry Chef” cards;
a deck of “Sous Chef” cards;
a deck of “1^{st} Cook” cards;
a deck of “Head Chef” cards;
a deck of “Chef Says” cards; and
a deck of “Dietitian” cards.

7. The game apparatus of claim 6, each of the plurality of cards in the deck of “Chef Says” cards provides instructions for each player to perform.

8. The game apparatus of claim 1, the at least one shortcut path comprising four shortcut spaces, each of the shortcut spaces is associated with at least one of the plurality of cards.

9. The game apparatus of claim 1, the game apparatus is a board game.

10. A method for playing a game comprising:
(a) positioning a first player piece representing one of a plurality of players on one of a plurality of starting spaces on a game board;
(b) determining an order for playing the game by rolling at least one six-sided die;
(c) answering a trivia question correctly or performing an action item based on instructions provided on a card associated with the starting space;
(d) rolling the at least one six-sided die to determine the new position of the first player piece on the game board, if the card comprises a trivia question;
(e) moving the first player piece along a travel path of the game board to one of a plurality of category spaces after correctly answering the trivia question or fully performing the action item instructed on the card;
(f) answering a trivia question correctly or performing an action item based on instructions provided on one of a plurality of cards associated with one of the plurality of category spaces;
(g) repeating steps (d) through (f) until the first player piece moves along the travel path and reaches the starting space;
(h) placing the first player piece on a finishing space after the first player piece reaches the starting space;
(i) positioning a second player piece representing the same player on the starting space;
(j) answering a trivia question correctly or performing an action item based on instructions provided on a card associated with the starting space;
(k) rolling the at least one six-sided die to determine the new position of the second player piece on the game board, if the card comprises a trivia question;
(l) moving the second player piece along a travel path of the game board to one of a plurality of category spaces after correctly answering the trivia question or fully performing the action item instructed on the card;
(m) answering a trivia question correctly or performing an action item based on instructions provided on one of the plurality of cards associated with one of the plurality of category spaces;
(n) repeating steps (k) through (m) until the second player piece moves along the travel path and reaches the starting space; and
(o) placing the second player piece on the finishing space once the second player piece reaches at least the starting space.

11. The method for playing a game of claim 10, the trivia question and the action item relate to a group consisting of food, food preparation, and nutrition.

12. The method for playing a game of claim 10, the plurality of cards are arranged in a plurality of decks, each of the plurality of decks is associated with a different category relating to a group consisting of food, food preparation, and nutrition.

13. The method for playing a game of claim 12, the plurality of decks comprising:
a deck of “Health Inspector” cards;
a deck of “Culinary Student” cards;
a deck of “Pastry Chef” cards;
a deck of “Sous Chef” cards;
a deck of “1^{st} Cook” cards;
a deck of “Head Chef” cards;
a deck of “Chef Says” cards; and
a deck of “Dietitian” cards.

14. The method for playing a game of claim 10, further comprising a first player winning the game by independently placing each of the first player piece and the second player piece on the finishing space.

15. The method for playing a game of claim 14, placing each of the first player piece and the second player piece on the finishing space comprising moving each of the first player piece and the second player piece around the travel path to the starting space.

16. The method for playing a game of claim 14, placing each of the first player piece and the second player piece on the finishing space comprising moving each of the first player piece and the second player piece through at least one shortcut path.

17. The method for playing a game of claim 16, the at least one shortcut path comprising a plurality of shortcut spaces.

18. The method for playing a game of claim 17, moving each of the first player piece and the second player piece through the at least one shortcut path comprising:
(a) positioning one of the first player piece or the second player piece on one of the plurality of category spaces that is directly adjacent to the at least one shortcut path;
(b) deciding to take the at least one shortcut path instead of the travel path; and
(c) rolling the at least one six-sided die to determine the new position of the first player piece or the second player piece on the at least one shortcut path;

19. The method for playing a game of claim 18, further comprising rolling at least a five on the at least one six-sided die to bypass each of the plurality of shortcut spaces and proceed directly to the finishing space.

20. The method for playing a game of claim 10, the game is a board game.
